(19) United States
(12) Patent Application Publication
(10) Pub. No.: US 2025/0278059 A1
(43) Pub. Date: Sep. 4, 2025

(54) SYSTEM AND METHOD FOR TRACKING FACE DAYS OF MOON SYNCHED TO GREGORIAN DATES

(71) Applicant: Casey C. Plouffe, Hopkins, SC (US)

(72) Inventor: Casey C. Plouffe, Hopkins, SC (US)

(21) Appl. No.: 19/196,007

(22) Filed: May 1, 2025

Related U.S. Application Data
(60) Provisional application No. 63/559,993, filed on Mar. 1, 2024.

(51) Int. Cl. G04B 19/26; G09D 3/12

(52) U.S. Cl. CPC G04B 19/268; G09D 3/12

(57) ABSTRACT

A system and method for integrating natural lunar synodic cycles with Gregorian calendar timelines to enhance planning and organization. The system includes a processing unit and memory configured to receive moon phase information, generate calendar information comprising synodic days within a synodic month, and associate each calendar cell with data elements representing a synodic day number, moon phase, and corresponding Gregorian date. The system renders this information via a graphical user interface for user interaction, enabling real-time updates based on astronomical data. Users can plan activities aligned with lunar cycles while maintaining synchronization with conventional calendars. The method involves receiving moon phase or user profile information, determining relevant content items, and outputting calendar information for user interaction, including moon phase indicators, synodic day numbers, and Gregorian dates. Applications include day planners and interactive tools for tracking personal energy patterns, scheduling, and aligning activities with natural rhythms.

### CROSS-REFERENCE TO RELATED APPLICATIONS

This application claims benefit to Provisional Application No. 63/559,993, filed Mar. 1, 2024, the contents of which are herein incorporated by reference.

### BACKGROUND OF THE INVENTION

The present disclosure pertains to calendaring systems, specifically to systems and methods for integrating natural lunar synodic cycles with Gregorian calendar timelines to facilitate planning and organization.

This disclosure pertains to calendaring systems and timekeeping methods that focus on alignment with natural lunar cycles. In numerous aspects of daily life, clocks and calendars are based solely on standardized, historically derived systems that may not align with the rhythms of nature. With modern lifestyles becoming increasingly disconnected from natural cycles, there is growing interest in exploring timekeeping concepts that acknowledge biological and environmental patterns. Many individuals have expressed a desire for tools that not only offer the familiar structure of conventional dates and weeks but also act as a reminder of the natural progression of time as demonstrated by the Moon's phases.

The goals of this approach are to offer a practical way for people to plan their activities in a manner that harmonizes both with the established global calendar and the more subtle, naturally occurring lunar cycles. By integrating these two systems, a user can potentially tap into a more organic rhythm for scheduling, which may support improved well-being and insight into personal energy patterns. This dual approach is intended to help individuals align their planning with the natural cycles of darkness and light while still remaining coordinated with broadly accepted timekeeping standards.

Current methodologies predominantly rely on an artificial framework that dates back centuries and does not naturally account for the cadence provided by the Moon's cycles. While there are systems that merely append lunar phase indications to conventional calendars, they often fail to integrate the natural rhythms of the Moon into the foundational structure of the calendaring system. This prevailing method overlooks the potential benefits of planning life's various activities in alignment with the organic progression of a synodic month, which guides periods of rest, action, and renewal. More specifically, conventional calendars do not designate a natural starting point that marks the transition from one lunar cycle to the next. Users of standard timekeeping tools are often left without a readily accessible means of directly correlating their daily activities and long-term planning with the cyclical nature of lunar phases. This shortcoming may contribute to a disconnect with natural phenomena that influence human physiology and emotion.

There is an opportunity to address this gap by establishing a system that commences with a natural dark phase marker and then integrates conventional dates for global synchronization, thereby offering a more balanced and intuitive way to structure daily life.

### BRIEF DESCRIPTION OF THE DRAWINGS

FIG. 1 is a schematic block diagram illustrating the Synodic Calendar Environment and the manner in which the Synodic Calendar Environment interacts with user devices and network systems;

FIG. 2 illustrates a schematic flow chart diagram of a method for generating face day information and interacting with calendar information based on moon phase and user profile data;

FIG. 3 illustrates a graphical user interface of a synodic calendar system displaying lunar face days, lunar phases, and corresponding Gregorian dates for a specific cycle;

FIG. 4A illustrates a graphical user interface (GUI) displaying moonrise and moonset times alongside one or more context items;

FIG. 4B illustrates a GUI for displaying one or more additional context items; and

FIG. 4C illustrates a GUI for displaying daily tasks and tracking personal vibrations during the lunar cycle.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The present disclosure pertains to calendaring systems and methods, and more specifically to a system for aligning natural lunar synodic cycles with Gregorian calendar timelines to support planning and organization.

Conventional calendaring systems, such as the widely adopted Gregorian calendar, are based on artificial constructs that were historically developed to standardize timekeeping across societies. While these systems provide a consistent framework for global synchronization, they fail to account for the natural rhythms of celestial phenomena, such as the lunar cycle. This disconnect between artificial timekeeping and natural cycles has led to a growing interest in alternative methods of organizing time that align more closely with the rhythms of nature.

The lunar cycle, which spans approximately 29.531 days from one new moon to the next, has long been recognized as a natural marker of time. However, modern lifestyles and calendaring systems often overlook the significance of this cycle, leaving individuals without tools to track or plan their lives in harmony with the Moon's phases, via a corresponding face day. This lack of integration can contribute to a sense of disconnection from natural phenomena that influence human physiology, emotional states, and energy levels.

The present disclosure addresses these shortcomings by providing a novel calendaring system that integrates the natural lunar synodic cycle with the Gregorian calendar in a unified and intuitive manner. This system centralizes the lunar cycle as the basis for monthly organization, creating a “moon month” that begins and ends with the dark moon phase, as a face day 0. Each moon month is structured to include the full progression of lunar phases, and corresponding face days, while simultaneously incorporating Gregorian dates and weeks for global synchronization.

By integrating the lunar cycle with the Gregorian calendar, the described system allows users to organize their lives in alignment with natural rhythms while remaining consistent with traditional timekeeping methods. The system offers a dual layout that enables users to monitor the lunar cycle alongside Gregorian dates, supporting both personal synchronization with the Moon's phases, via a corresponding face day, and effective coordination with others. Furthermore, the system incorporates functionalities for monitoring personal energy patterns, planning activities, and noting significant dates, providing a versatile tool for time management that connects natural and conventional timekeeping approaches.

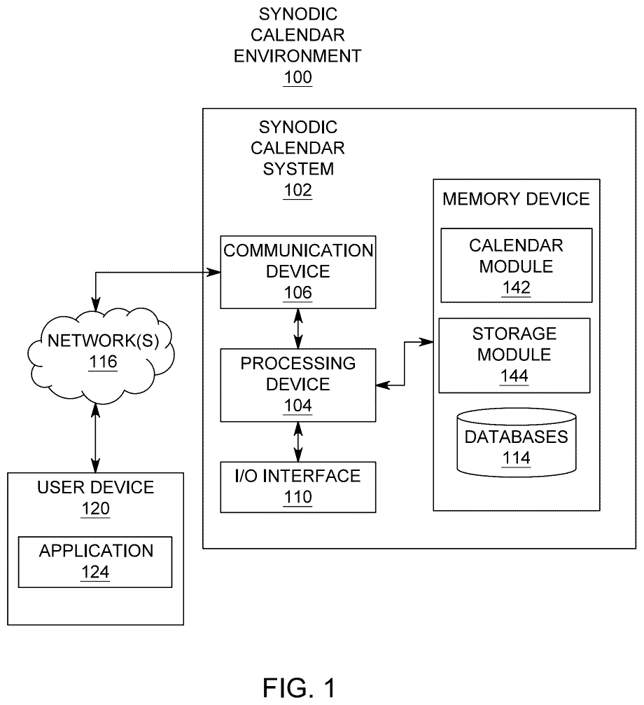

FIG. 1 illustrates a Synodic Calendar Environment 100 and the manner in which the Synodic Calendar Environment interacts with user devices and network systems. The Synodic Calendar System 102 includes one or more processing devices, herein processing device 104, coupled to a communication device 106. The processing device 104 is also coupled to a memory device 108, and an input/output (“I/O”) interface 110. In embodiments, the communication device 106 enables the system 102 to communicate with other devices and systems via one or more networks 116. The Synodic Calendar system 102 can communicate with a user device 120 via the network 116. A user can utilize the user device 120 to communicate with the Synodic Calendar System 102. The user device 120 can include one or more electronic devices such as a laptop computer, a desktop computer, a tablet computer, a smartphone, a thin client, a smart appliance, and the like. While FIG. 1 illustrates one user device 120, the Synodic Calendar Environment 100 can include multiple user devices operated by the user or operated by other users.

According to the aspects of the present disclosure, the Synodic Calendar System 102 enables the user, operating a copy of an application 124 executing on the user device 120, to communicate with the system 102 and leverage the service provided by the Synodic Calendar System 102. Alternatively, user device 120 in combination with application 124 can be Synodic Calendar System 102. The Synodic Calendar System 102 is configured to provide a Synodic Calendar, as illustrated in FIG. 1, to a user which is configured to organize a month from a dark moon phase to a dark moon phase, using a face day corresponding to each moon phase, while also providing a mapping to the Gregorian dates of the month, and providing one or more contextual items associated with elements of the Synodic Calendar.

To perform the process described herein, the Synodic Calendar System 102 can store and execute a Calendar module 142, and a storage module 144 to perform the processes and methods described herein. The Calendar module 142, and the storage module 144 can be stored in memory device 108. The Calendar module 142, and the storage module 144 can include the necessary logic, instructions, and/or programming to perform the processes and methods described in further detail below. The Calendar module 142, and the storage module 144 can be written in any programming language.

In embodiments, the application 124 can be a specifically designed application that operates with the Synodic Calendar System 102 to perform the processes and methods described herein. In embodiments, the application 124 can be a third-party application, such as a web browser, that communicates with the Synodic Calendar System 102 to perform the processes and methods described herein. The memory device 108 can also include one or more databases 114 that store information and data associated with the process and methods described below in further detail.

According to aspects of the present disclosure, system 102, for example, via the Calendar module 142, provides unique interfaces that allow the user 122 to look at months, enter planning information, determine important dates, etc. The Calendar module 142 operates to generate and provide graphical user interfaces (GUIs) to the application 122, for example, menus, widgets, text, images, fields, etc., as described below in further detail. The GUIs generated by the Calendar module 142 can be interactive. The Synodic Calendar System 102, for example, via the calendar module 142, also provide one or more application programming interface (APIs) that provide connection points for one or more application, e.g., the application 124.

In embodiments, the Calendar module 142 can implement voice control aspects into the interfaces provided. For example, the user can navigate the interfaces of the Synodic Calendar System 102 using the audio input device of the user device 120. The Calendar module 142 can implement one or more chat-bots to deliver conversational input and output to a user.

In embodiments, the Calendar module 142 can include a plurality of submodules, such as, but not limited to, a rituals sub-module, a ceremonies sub-module, an explorations sub-module, a profile sub-module, a retreats sub-module, a store sub-module, a sacred partnerships sub-module, a community sub-module, a social media sub-module, etc.

In embodiments, the Calendar module 142 is configured to create and organize at least one calendar information, such as a Synodic Calendar, in accordance with aspects of the present invention. In embodiments, at least one calendar information, as a Synodic Month Calendar, is arranged to include a full synodic month, i.e. beginning with a dark moon. The Calendar is arranged by determining the moon cycles utilizing Calendar module 142. Depending on the elliptical orbit of the Earth and the Moon's declination, which both contribute to how early a moonrise occurs, or how late a moonset happens, the moon face day fluctuates between 28 and 29. The dark face day can be Face day zero and each moon month starts with a dark moon. A synodic month, traversal from dark face to dark face of the moon, is 29.531 days, and rise and set times can either yield a total of 28 or 29 face days within a cycle. Counting face 0 as a day yields 29-30 faces for each cycle. In embodiments, Calendar Module 142 can retrieve and/or calculate moon cycles. Additionally, Calendar Module 142 can organized each day box in the synodic month to include a synodic day, i.e. face day, along with a phase of the moon. In an exemplary embodiment, phase of the moon can be one of a dark moon, waxing crescent, first quarter, waxing gibbous, full moon, waning gibbous, last quarter, and waning crescent. In embodiments, Calendar Module 14 can retrieve or otherwise determine moon phases and organize the calendar information accordingly. Additionally, the day box includes a Gregorian date, including the Date and Month, to match the synodic calendar with the Gregorian calendar. Advantageously, Calendar Module 142 can provide one or more user interfaces, or user interface elements, configured to allow a user to interact with a day box, such as space to write, or otherwise record, information that can be pertinent to the day box. In an embodiment, information that can be pertinent to the day can include any demographic, planning, health, or information otherwise that can be considered reasonably pertinent to a user of Calendar System 102.

The a rituals sub-module is configured to delivers daily or cycle-specific rituals uniquely aligned with each Face Day of the lunar synodic cycle. Unlike traditional moon phase systems, rituals are mapped directly to the daily Face Day structure (e.g., Face Day 0=Rest/Dark Moon, Face Day 1=Intention Setting).

The ceremonies sub-module is configured to provide live or replayable ceremonies aligned with key Face Day cyclical events, seasonal gateways (e.g., equinoxes, solstices).

The explorations sub-module is configured to provide content that supports users in understanding and embodying Face Day tracking, that pulls Gregorian day and time data. It includes how to use this innovative face day tracking system while bridging Gregorian calendar dates with the lunar-based Face Day layout for ease of real-world application and embodiment.

The profile sub-module is configured allow a user creates a personal profile to track their individual Face Day experiences, including syncing menstrual cycles, energy levels, and patterns of emotion or creativity. This allows for long-term recognition of personal energetic rhythms they experience that sync with the face day illumination and shadow. This will help them align their life with the Face day energetic patterns and they can easily organize their life thanks to us pulling Gregorian data for this revolutionary Face Day lunar tracking system.

The retreats sub-module is configured to provide digital and in-person retreat experiences that are synched around face days and solar seasons.

The store sub-module is configured to provide a curated shop featuring tools, guides, and products aligned with the current Face Day as well as our printed tracking system calendar.

The sacred partnerships sub-module is configured to provide a space for us to collaborate in sacred partnership with those embracing this tracking system as a way of life

The community sub-module is configured to provide a social space where users can connect and share based on the current Face Day. Prompts may invite users to post intentions, gratitude, photos, or ritual reflections. The community space is designed to foster cyclical face day awareness and align collective energy around each Face Day's, while referencing Gregorian date data.

The social media sub-module is configured to provide a simple link or landing area where users can connect with the brand on external platforms such as Instagram, YouTube, or other channels. This may also host shareable Face Day affirmations or visuals users can repost to inspire cyclical Face Day living in their broader networks.

The Music & Affirmation Synchronization Sub-Module is configured to provide daily Face Day-specific music and affirmations aligned with the energetic tone of each day in the 29.531-day lunar cycle. In embodiments, music is linked to platforms or original tracks designed to entrain the nervous system to the resonance of that Face Day. In embodiments, Affirmations are drawn from our archive, i.e. database 114 and curated to reflect the emotional and spiritual themes of each Face Day (e.g., Face Day 4=Amplify; Face Day 27=Letting Go). These offerings are responsive to user time zone and hemisphere, enhancing personalization and embodiment of the Face Day cyclical framework, while tracking Gregorian date.

The processing device 104, the communication device 106, the memory device 108, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the Synodic Calendar System 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 108, the Synodic Calendar System 102 can include multiple memory devices 108, whether the same type or different types.

The communication device 104 enables the Synodic Calendar System 102 to communicate with other devices and systems. The communication device 104 can include, for example, a networking chip, one or more antennas, and/or one or more communication ports. The communication device 104 can generate radio frequency (RF) signals and transmit the RF signals via one or more of the antennas. The communication device 104 can generate electronic signals and transmit the RF signals via one or more of the communication ports. The communication device 104 can receive the RF signals from one or more of the communication ports. The electronic signals can be transmitted to and/or from a communication hardline by the communication ports. The communication device 104 can generate optical signals and transmit the optical signals to one or more of the communication ports. The communication device 104 can receive the optical signals and/or can generate one or more digital signals based on the optical signals. The optical signals can be transmitted to and/or received from a communication hardline by the communication port, and/or the optical signals can be transmitted and/or received across open space by the communication device 104.

The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The Synodic Calendar System 102 can communicate with one or more network resources via the network 116. The one or more network resources can include external databases, social media platforms, search engines, file servers, web servers, or any type of computerized resource that can communicate with the system 102 via the network 116.

As described above, the Synodic Calendar System 102 can include hardware components to perform the processes described herein. In embodiments, one or more of components, hardware, and/or functionality of the Synodic Calendar System 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the Synodic Calendar System 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the Synodic Calendar Environment 100, including the Synodic Calendar System 102 and/or the user device 120 can provide I/O devices for outputting information in a format perceptible by a user and receiving input from the user. For example, the Synodic Calendar System 102 can communicate with the I/O devices via the I/O interface 110. The I/O devices can display graphical user interfaces (“GUIs”) generated by the Synodic Calendar System 102. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

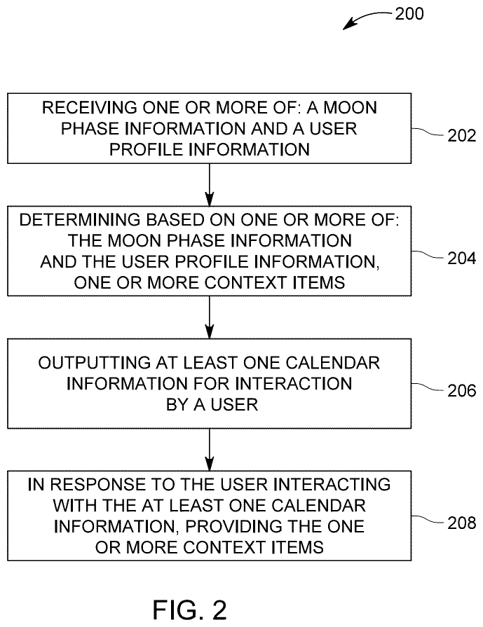

FIG. 2 shows an overall method 200 implementable in Calendar module 142 for generating and interacting with calendar information based on moon phase information 202 and user profile information 202.

Method 200 begins with receiving one or more of a moon phase information and a user profile information 202. This step involves the acquisition of data related to the lunar cycle, such as the current moon phase, and user-specific information, which may include preferences, historical activity patterns, or other profile attributes. This data serves as the foundational input for subsequent processing and customization within the system. In embodiments, moon phase information can be extracted, pulled, or otherwise received by Calendar module 142 from one or more internal or external data sources, and can include the phase of the moon, such as a dark (new) moon, waxing crescent, first quarter, waxing gibbous, full moon, waning gibbous, third quarter, and waning crescent, moonrise/moonset data, and the corresponding Gregorian dates associated with each phase of the moon. In embodiments, moon phase information can be utilized to organize at least one calendar information. For example, moon phase information is utilize to determine a face day for at least one calendar information, as described further hereinafter.

Next, the method proceeds to determining, based on one or more of the moon phase information 202 and the user profile information, one or more content items 204. This step involves analyzing the received data to identify relevant content items that align with the user's profile and the current lunar phase. The content items may include one or more of themes, personalized insights, recommendations, scheduling suggestions, affirmations, informational items, or other contextual information tailored to the user's needs and the natural lunar cycle.

In embodiments, the one or more content items can be indexed in a database, such as database 114, using the face day associated with the moon phase information. In embodiments, each face day can include a theme which can be retrieved using the face day as an index. In an exemplary embodiment, the themes are as follows:

Face Day 0—Holy Dark Void, Theme: Womb Space. Nourish & Rest. Return to the dark womb. Rest. Be held. Nourishment begins here. This is a day of sacred stillness—not a time of doing, but of simply being. Sink into the void. Let it hold you. Let yourself be mothered by the mystery.

Face Day 1—Compassion is the Fertilizer, Theme: Intentional Forgiveness. Spaciousness. Faith. Have compassion for your past. Choose to see your life as sacred compost-everything was for your growth. Release doubt. Plant new intentions with faith and tenderness. Your human journey is worthy of grace.

Face Day 2—Divine Recognition, Theme: Seeding with Sovereignty. Recognize yourself as a Divine Birther, capable of birthing new realities. Every thought is a seed. What will you plant today? How will you nourish your inner soil? Align your mental landscape with the truth of your true power, which is being a child of the Divine made in the exact image of your creator/creatrix parents.

Face Day 3—Heart-Womb Planting, Theme: Intentional Rooting of Seeds Drop deeply into your heart-womb. With love and care, plant your intentions within your heart. This is sacred work-quiet, conscious, and felt. Anchor your vision in embodied prayer.

Face Day 4—Amplifying Your Seeds of Intention Through Stillness, Theme: Inner Fertile Ground. Go inward. Tend the soil before the sprout. Stillness is strength. Refine your focus in the quiet. The richest intentions are nourished below the surface.

Face Day 5—Strengthening Your Intention, Theme: Charge the Light Within Your inner light is rising with the moon. Continue to amplify what matters. Water your vision with breath and presence. Expansion comes when rooted in silence.

Face Day 6—Initiating Growth, Theme: Conscious Movement Toward Growth. It's time to take action. Let the gardener within you rise-tending, pruning, and feeding your sacred seeds. Move from intention into alignment. Ride the creative edge with clarity.

Face Day 7—Preservation & Destruction, Theme: Sacred Discernment What must be preserved? What must be destroyed? Creation is born from what you choose to let go of. Use your sacred sword with wisdom.

Face Day 8—Creative Action, Theme: Aligned Action. Take inspired steps forward. Use the momentum of the waxing moon to express, create, and embody your vision with joy and precision.

Face Day 9—Deep Communion, Theme: Union Within. Make space to commune with yourself. Where are your polarities out of sync? Unite the inner masculine and feminine. Wholeness is your foundation.

Face Day 10—Inner Harmony & Reverence, Theme: Sovereignty Through Responsibility. You are the sovereign architect of your reality. Take full responsibility—with love—for your balance, your power, and your creations. Commune with everything in your reality. What is your reality informing you of? Are your actions aligned with your intention?

Face Day 11—The Inner Playful Child, Theme: Joyful Creation. Let joy lead today. Be playful in your process. “Fun gets more done.” Let your inner child move the brush, write the words, dance the prayer.

Face Day 12—Creative Presence & Play, Theme: Spontaneous Inspiration. Be present. Be light. Notice the synchronicities. Inspiration is arising all around you. Let your joy speak before your logic answers.

Face Day 13—Shining Bright, Theme: The Full Radiance of Love. You are glowing. Feel it. Let yourself be seen. Let the moon mirror your brilliance. Feel the immensity of love pulling you open.

Face Day 14—Infinite Possibility, Theme: No Limits. Pure Potential. The fullness of the moon reminds you: there are no limits but the ones you believe in. Expand. Imagine. Activate a new timeline.

Face Day 15—Responding to Beauty, Theme: Living in Reverence. With an open heart, respond to the beauty of life. Let awe guide you. Let beauty become your devotion. Keep making your life beautiful!

Face Day 16—Fueling with Gratitude, Theme: Harvest & Recharge. Gratitude is your fuel now. Absorb the light you're cultivating. Give thanks for all that's blooming. The transition has begun-ride it. Fuel with the elements and nourish yourself to ride this waning phase of the cycle.

Face Day 17—Sacred Life Force, Theme: Shakti Activation. Your sexual and creative energy is sacred. Honor the fire that births worlds through you. Channel it with reverence. Push through, as the transition to wane is upon you.

Face Day 18—Facing the Mirror of Initiation, Theme: Radical Self-Honesty. You are the creator of your experience. Own it all—not from shame, but from power. Your shadow holds the keys. Life is the initiator.

Face Day 19—Aligning & Growing, Theme: Integration Through Initiation. Every challenge is an invitation. Align your lifestyle with your soul. Growth is happening. Choose to receive it consciously. Remain humble. Clarify what needs clarity. Your feelings let you know.

Face Day 20—Wisdom Through Simplification, Theme: Return to Essence. What is truly necessary? Simplify. Purify. Wisdom often whispers once we quiet the noise. Your initiations are asking for simplicity. Where can you simplify?

Face Day 21—Keep What Resonates, Theme: Energetic Pruning. Cut what drains. Keep what sustains. This is a day to keep clearing the clutter and choose what feels true. What resonates? Allow only that which resonates with your soil to remain.

Face Day 22—Resonance of Simplicity, Theme: Savor What's Sacred. Let joy be simple. Tune in to what resonates now. Integration doesn't need to be loud-only true.

Face Day 23—Dreaming Heaven, Theme: Visioning the New Earth. Let yourself dream wide and wild. You are co-creating heaven on earth. Have faith in this truth. Imagine. Feel it. See your vision. FEEL IT!!!!

Face Day 24—Birthing a New World, Theme: From Inner to Outer. Your inner world is becoming form. Hold it gently. Birth with faith. Trust the invisible architecture. Keep going inward to see it and FEEL IT!

Face Day 25—Weaving Creation, Theme: Sacred Birthing and Midwifing. Weave the threads. Align the lessons. Craft the new world one intention at a time. Weave your dreams by going inward to FEEL THEM! SEE THEM! WEAVE THEM!

Face Day 26—Releasing the Old, Theme: Let It Fall Away with Trust. Release the story, the shell, the spell. Let go with grace. Trust the Great Mystery to preserve it all as you prepare for regeneration and rebirth.

Face Day 27—Letting Go, Theme: Liberation Through Release. Releasing it all is power. Lay it all down and trust the unfolding. Death births new life. Free yourself from trying to control it all. Trust the Divine Mother and Father to handle it!

Face Day 28—Preparing for Renewal, Theme: Sacred Surrender. Make space. Clear the altar. Rest your mind. Renewal begins in the empty womb.

Face Day 29—Returning to the Void, Theme: Emptying the Vessel. You are returning back at the cosmic zero point. Dissolve. Trust. Be held in the holy dark. Emptiness creates the room for birthing miracles and heaven on earth!

In embodiments, the face day and/or the theme can index one or more additional content items such as personalized insights, recommendations, scheduling suggestions, affirmations, informational items, or other contextual information tailored to the user's needs and the natural lunar cycle, which can be retrieve and provided for output, as outlined in 204.

Following the determination of content items 204, the method outputs at least one calendar information, such as a day, week, month, year, etc., for interaction by a user 206. This step involves presenting the user with calendar information that integrates the lunar phase data and user-specific content. The calendar information may include visual representations of the lunar cycle, synodic month tracking, and corresponding Gregorian dates, along with interactive elements that allow the user to engage with the displayed information. Importantly, the at least one calendar information, such as a day, week, month, year, etc., can be organized with the first day being the dark moon day, i.e. face day 0, thereby effectively aligning the at least one calendar information with the synodic calendar. In embodiments, face day 0, i.e. dark moon day, can be the first day of the Synodic month, and each of the at least one calendar information following face day 0 can be labeled as a face day with a monotonically increasing number, until the month is over, and a next month starts with face day 0, on a dark moon. In embodiments, each of the calendar information, as a day, can include a visual representation of the lunar cycle, a synodic day, i.e. face day, associated with the lunar cycle, a Gregorian date corresponding to the synodic day, and/or one or more content items associated with the day.

In exemplary embodiments, one or more face days can be assigned to one or more lunar cycles as follows: face day 0 is associated with the new moon, face days 1-3 are each associated with the first three phases on the waxing crescent, face days 4-5 are each associated with the last two phases of the waxing crescent, face days 6-8 are associated with the three phases of the waxing quarter moon, face days 9-10 are associated with the first two phases of the waxing gibbous, face days 10-11 are associated with the last two phases of the waning gibbous, face days 13-15 are associated with the three phases of the full moon, face days 16-17 are associated with the first two phases of the waning gibbous, face days 18-19 are associated with the last two phases of the waning gibbous, face fays 20-22 are associated with the three phases of the waning quarter moon, face days 23-25 are associated with first three phases of the waning crescent, face days 26-27 are associated with the last two phases of the waning crescent, and face days 28-0 the end dark moon.

In response to the user interacting with the at least one calendar information 206, the method provides the one or more context items 208. This step enables dynamic interaction between the user and the system, where the user's engagement with the calendar information triggers the delivery of the previously determined context items. These context items may include personalized insights, mood tracking features, or activity planning tools, enhancing the user's ability to align their schedule with natural lunar rhythms and their personal energy patterns. In embodiments, the context items can be one or more interactive modules, programs, processes, etc., that the user can interact with, such as one or more interactive recommendations, which when interacted with provide one or more content items, such as text, audio, visual, multimedia, video, music, etc., one or more journals, one or more planners for tasks, times, and/or reminders, and/or one or more feeling, mood, or vibration indicators.

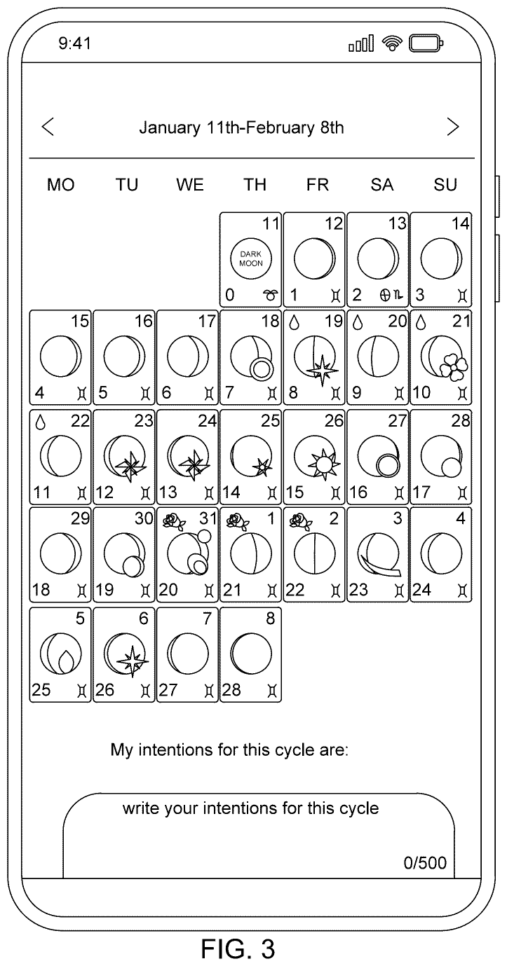

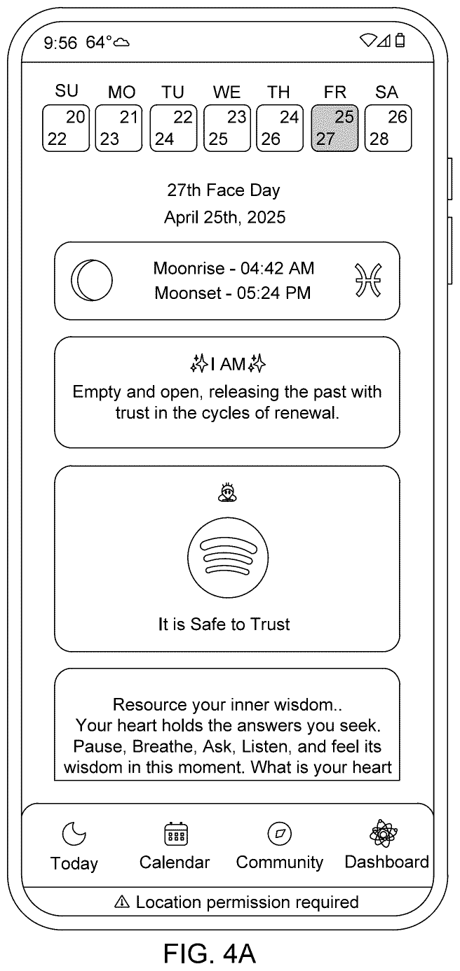

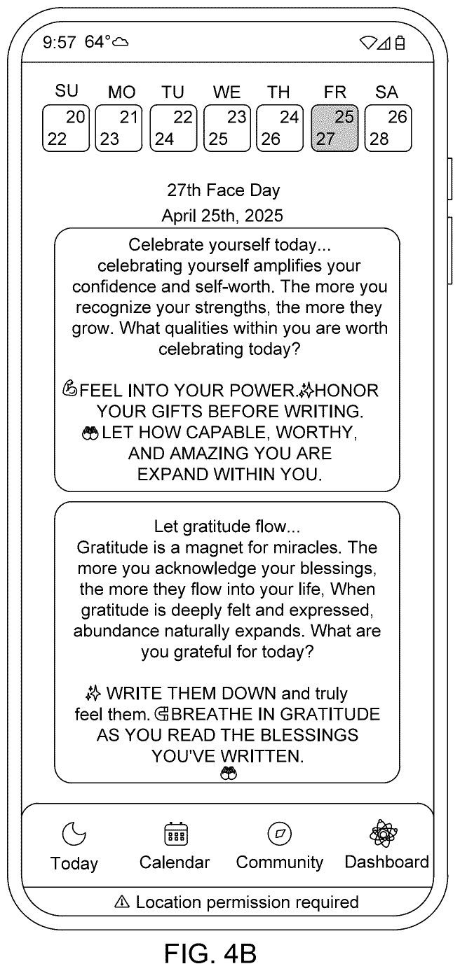

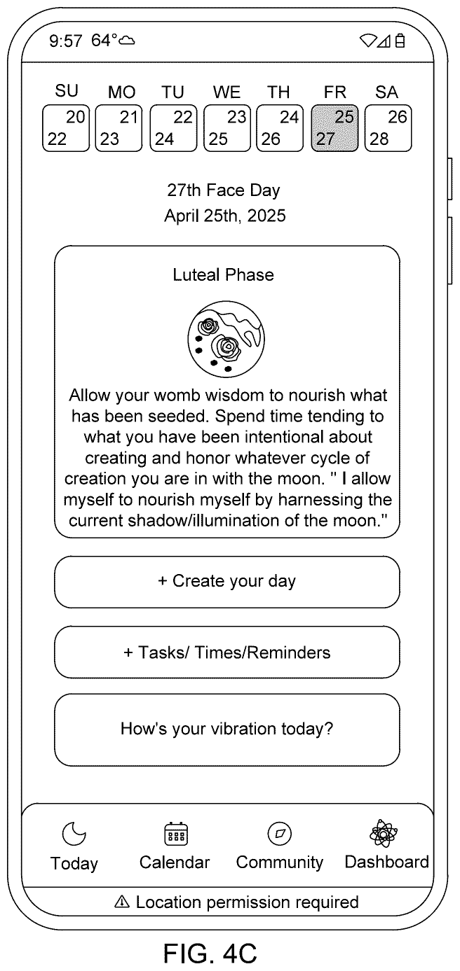

Referring to FIG. 3, a User Interface of a month view of a Synodic calendar, created using Calendar Module 142 and/or performing method 200, on a user device 120, running an application 124, is illustrated. FIG. 3 illustrates a synodic month running from January 11^{th}-February 8^{th}. For example, day box for Gregorian date January 11^{th}, a Thursday, can be the first day of a Synodic month that starts with a dark moon, as illustrated with a black moon icon in the day box. The day box for January 11^{th} can include a synodic day, i.e. face day 0, in a lower left portion of the day box. Day boxes can include, in addition to an icon for the moon phase, various icons relating to astrological symbols, important dates, etc. FIG. 3 can include a textbox where a user can enter their intentions for a specific cycle. In embodiments, each day box can be one of the at least one calendar information, as described with reference to FIG. 2 and can include at least a moon phase information (icon representing the moon phase), a synodic day associated with the moon phase information (i.e. a face day or monotonically increasing number staring with dark moon as day 0), a Gregorian Date associated with the synodic day, etc. In operation, a user can interact with the day box, as one of the at least one calendar information, which results in the display of one or more additional user interfaces having the one or more content items, as described with reference to FIG. 2 and in more detail with respect to FIGS. 4-C.

Referring to FIGS. 4A-C, one or more user interfaces of a view of a Synodic calendar, on a user device 120, running application 124, is illustrated. More specifically, the one or more user interfaces are the result of the user interacting with a day box, as one of the at least one calendar information, as described with reference to FIG. 2. The view, as illustrated, can display day boxes for a Monday through Sunday week of a given month. Each day box can include the Gregorian Date in an upper right corner, and the Synodic date at a lower left corner. Advantageously, the inventive week view can allow for alignment of Gregorian Dates with Synodic Dates.

Additionally, for the day box selected, one or more content items is provided, as outlined with reference to FIG. 2. In embodiments, the one or more content items can include moonrise/moonset information, one or more prompts/messages/affirmations/empowerments, and/or one or more icons to access additional content, such as multimedia content (as illustrated in FIG. 4A). The one or more content items can include one or more informational items, relevant to the day selected, and/or one or more prompts (as illustrated in FIG. 4B). Finally, the one or more content items can include one or more additional interactive elements, such as one or more journals, one or more planners for tasks, times, and/or reminders, and/or one or more feeling, mood, or vibration indicators (as illustrated in FIG. 4C). In embodiments, interaction with one or more interactive elements can take the user to a different interface where information can be viewed/added/edited/ingested or otherwise interacted with, and if necessary, the information can be saved in association with the selected day box. For example, one or more journal entries, tasks, plans, reminders, can be entered and stored (in application 124 or otherwise transmitted and stored in databases 114), such that the user has a record of information provided or relevant to a specific day.

In embodiments, the computer-implemented method and systems of the present invention utilize a novel method of calendar organization. In embodiments, the lunar phases of the moon are collected from dark moon phase, through the all phases of the moons progression, to a next dark moon phase. In embodiments, a calendar is organized the phase information to dictate a plurality of face days on the calendar. In embodiments, the dark moon phase is face day 0, a monotonically increasing face day is associated with each subsequent day, which has its own moon phase, ending the day before the next dark moon, which would reset the calendar to face day 0. In embodiments, each face day can be associated with a Gregorian date associated with the face day (as illustrated in FIG. 3, i.e. an exemplary synodic month). In embodiments, face day 0 forms the beginning of the synodic moth, regardless of the Gregorian date associated with the face day, and the synodic month proceeds to face day 28 (or 29 depending on the moon phases) as the end of the month.

In exemplary embodiments, one or more face days can be assigned to one or more lunar cycles as follows: face day 0 is associated with the new moon, face days 1-3 are each associated with the first three phases on the waxing crescent, face days 4-5 are each associated with the last two phases of the waxing crescent, face days 6-8 are associated with the three phases of the waxing quarter moon, face days 9-10 are associated with the first two phases of the waxing gibbous, face days 10-11 are associated with the last two phases of the waning gibbous, face days 13-15 are associated with the three phases of the full moon, face days 16-17 are associated with the first two phases of the waning gibbous, face days 18-19 are associated with the last two phases of the waning gibbous, face fays 20-22 are associated with the three phases of the waning quarter moon, face days 23-25 are associated with first three phases of the waning crescent, face days 26-27 are associated with the last two phases of the waning crescent, and face days 28-0 the end dark moon.

Further aspects of the invention are described in the Appendix, attached hereto. It should be understood, of course, that the foregoing relates to exemplary embodiments of the invention and that modifications may be made without departing from the spirit and scope of the invention as set forth in the following claims.

What is claimed is:

1. A synodic calendar system for integrating natural lunar cycles with Gregorian dates, comprising:
a processing unit configured and a memory storing instructions which, when executed by the processing unit, cause the system to:
receive at least one moon phase information;
generate calendar information comprising a plurality of calendar cells arranged to represent individual synodic days within a synodic month based on the moon phase information;
associate in each calendar cell of the plurality of calendar cells one or more data elements representing a face day number, an indication of a corresponding moon phase, and an associated Gregorian date; and
an input/output interface operable to render the generated calendar information via a graphical user interface for user interaction,
wherein the system further includes a communication module configured to receive the at least one moon phase information, and to update the generated calendar information in real time, thereby enabling users to plan and organize activities in alignment with both natural lunar synodic cycles and the conventional Gregorian timeline.

2. The system of claim 1, further comprising:
in response to a user interaction with the graphical user interface, determining a calendar cell interacted with, and
provide one or more content items based on the calendar cell interacted with.

3. A computer implemented method for creating a Synodic Calendar, comprising:
receiving a plurality of moon phase information or a user profile information;
determining, based on the moon phase information or the user profile information, one or more content items;
Outputting, based on the moon phase information, at least one calendar information for interaction by the user, the at least one calendar information including: a plurality of cells, each of the plurality of cells having: one of the plurality of moon phase information, a face day associated with the one of the plurality of moon phase information, wherein the face day is a monotonically increasing number starting at 0, and a Gregorian date associated with the one of the moon phase information, wherein the plurality of cells are organized starting with the face day 0;
In response to an interaction with the at least one calendar information, providing the one or more content items.

4. The computer implemented method of claim 3, wherein providing the one or more content items further comprises:
Searching, using the face day, one or more repositories to retrieve the one or more content items, wherein the one or more content items are contextually relevant to the face day.

5. A method of generating a Synodic Calendar, the method comprising:
receiving a plurality of moon phases information, wherein the moon phase information includes a plurality of moon phases starting from a dark moon phase;
labeling each moon phase with a face day, wherein the face day is a monotonically increasing number and wherein a first face day of the plurality of face days is 0 and is associated with the dark moon phase;
generating the Synodic Calendar having a plurality of months, wherein each of the plurality of months begins on the first face day.
